(19) United States
(12) Patent Application Publication
(10) Pub. No.: US 2017/0224156 A1
(43) Pub. Date: Aug. 10, 2017

(54) GRILLING APPARATUS HAVING A CONTAINING RECESS FOR RECEIVING A FEEDING SEAT WHEN IDLING

(71) Applicant: Tsann Kuen (Zhangzhou) Enterprise Co., Ltd., Zhangzhou (CN)

(72) Inventors: Wenyu Chang, Zhangzhou (CN); Xiaoyue Zhu, Zhangzhou (CN)

(73) Assignee: Tsann Kuen (Zhangzhou) Enterprise Co., Ltd., Zhangzhou (CN)

(21) Appl. No.: 15/416,308

(22) Filed: Jan. 26, 2017

(30) Foreign Application Priority Data
Feb. 5, 2016 (CN) 201610081882.8

(51) Int. Cl. A47J 37/06

(52) U.S. Cl. CPC A47J 37/0611

(57) ABSTRACT

A grilling apparatus includes a case unit and a feeding seat. The case unit has a containing recess for detachably receiving the feeding seat.

### CROSS-REFERENCE TO RELATED APPLICATION

This application claims priority of Chinese Patent Application No. 201610081882.8, filed on Feb. 5, 2016.

### FIELD

The disclosure relates to a grilling apparatus, and more particular to a grilling apparatus having a containing recess for receiving a feeding seat when the grilling apparatus is idling.

### BACKGROUND

Referring to FIGS. 1 and 2, a conventional grilling apparatus includes a lower grilling plate 11, an upper grilling plate 12 and a feeding seat 13.

The lower grilling plate 11 and the upper grilling plate 12 define a grilling space 14 therebetween, and are operable to cover or uncover the grilling space 14. The upper grilling plate 12 includes an upper case 122, and a grilling plate 121 that is mounted to the upper case 122 and that cooperates with the upper case 122 to define a delivering passage 123 that is in spatial communication with a center of the grilling space 14. The feeding seat 13 includes a body 131 and a handle 132 fixedly connected to a top portion of the body 131. The body 131 is detachably mounted to the upper case 122, and defines a feeding passage 133 that is in spatial communication with the delivering passage 123 and the grilling space 14.

In a process of making, for example, waffles, a user can pour a batter into the feeding seat 13. Since the delivering passage 123 is in spatial communication with the grilling space 14, the batter is evenly distributed from the center of the grilling space 14 to a periphery of the grilling space 14, thereby obtaining waffles with better quality. After use, the feeding seat 13 may be detached from the upper case 122 of the upper grilling plate 12 for cleaning. After cleaning, the feeding seat 13 may be remounted to the upper case 122. However, this may result in the requirement of a larger storage space for the conventional grilling apparatus. On the other hand, if the user chooses not to mount the feeding seat 13 back to the upper case 122, it is necessary to find a storage place for the feeding seat 13.

### SUMMARY

Therefore, an object of the present disclosure is to provide a grilling apparatus that can alleviate at least one of the drawbacks associated with the prior art.

According to the present disclosure, a grilling apparatus includes a case unit and a feeding seat. The case unit 201 has a containing recess for detachably receiving the feeding seat.

### BRIEF DESCRIPTION OF THE DRAWINGS

Other features and advantages of the present disclosure will become apparent in the following detailed description of the embodiment and variation with reference to the accompanying drawings, of which:

FIG. 1 is an exploded perspective view of a conventional grilling apparatus;

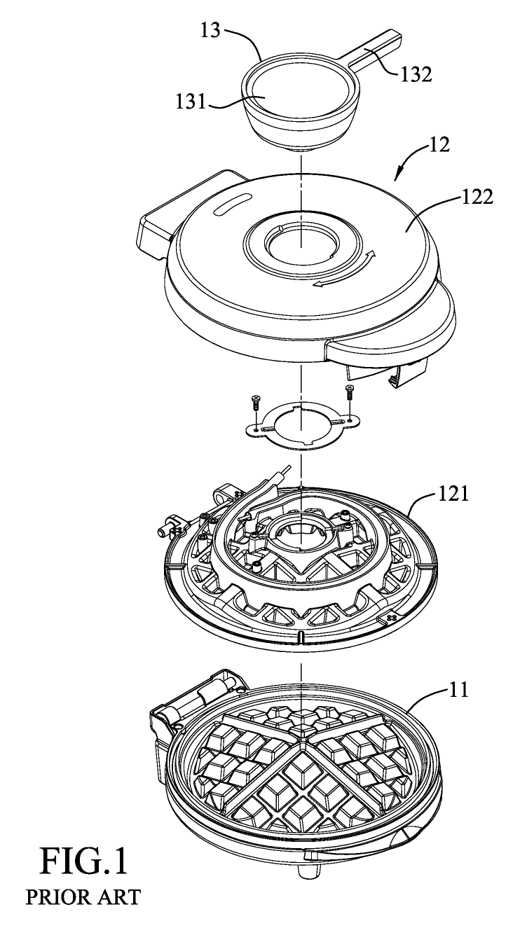

FIG. 2 is a sectional view of the conventional grilling apparatus;

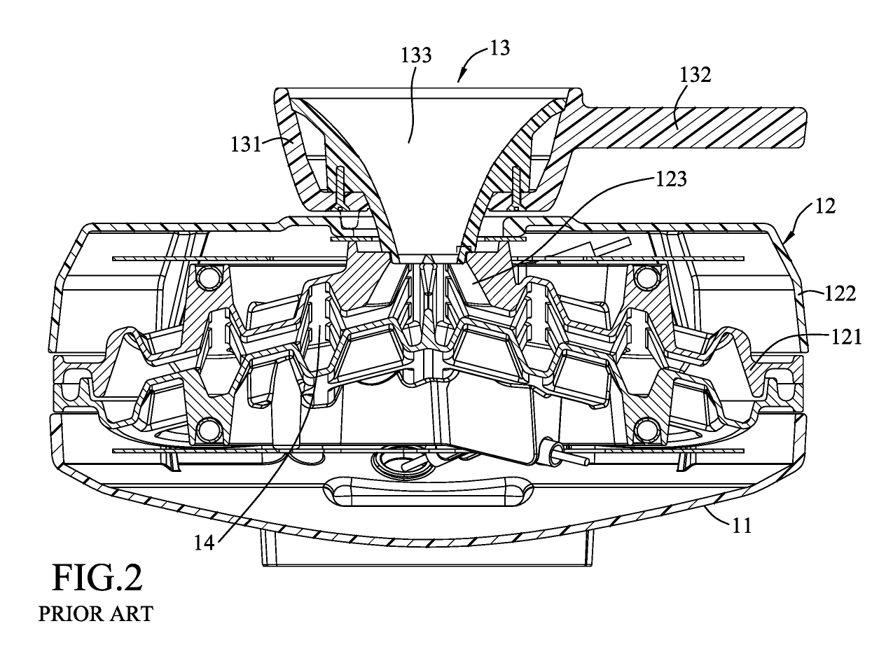

FIG. 3 is a schematic perspective view of an embodiment of a grilling apparatus according to the present disclosure showing a feeding seat to be mounted to an upper case unit of a case unit;

FIG. 4 is a schematic perspective view of the embodiment showing the feeding seat to be received in a containing recess;

FIG. 5 is a sectional view of the embodiment;

FIG. 6 is a bottom view of the embodiment showing the feeding seat being rotated to a removable position;

FIG. 7 is a sectional view of the embodiment taken along line VII-VII of FIG. 6;

FIG. 8 is a schematic view of the embodiment showing the feeding seat at the removable position;

FIG. 9 is a bottom view of the embodiment showing the feeding seat being rotated to a confined position;

FIG. 10 is a sectional view of the embodiment taken along line X-X of FIG. 9;

FIG. 11 is a schematic view of the embodiment showing the feeding seat at the confined position; and

FIG. 12 is a perspective view of a variation of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

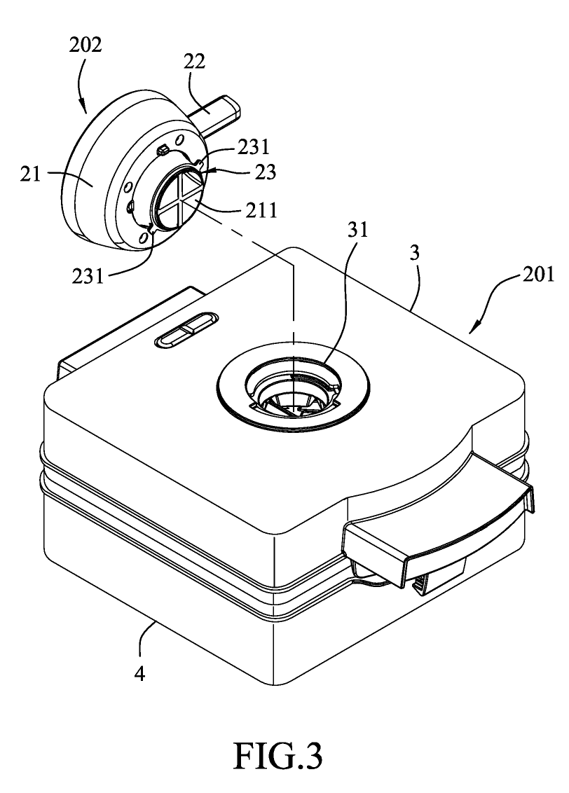

Referring to FIGS. 3 to 5, an embodiment of a grilling apparatus according to the present disclosure is used for cooking a food material. In this embodiment, the food material may be, but is not limited to, a batter for making waffles.

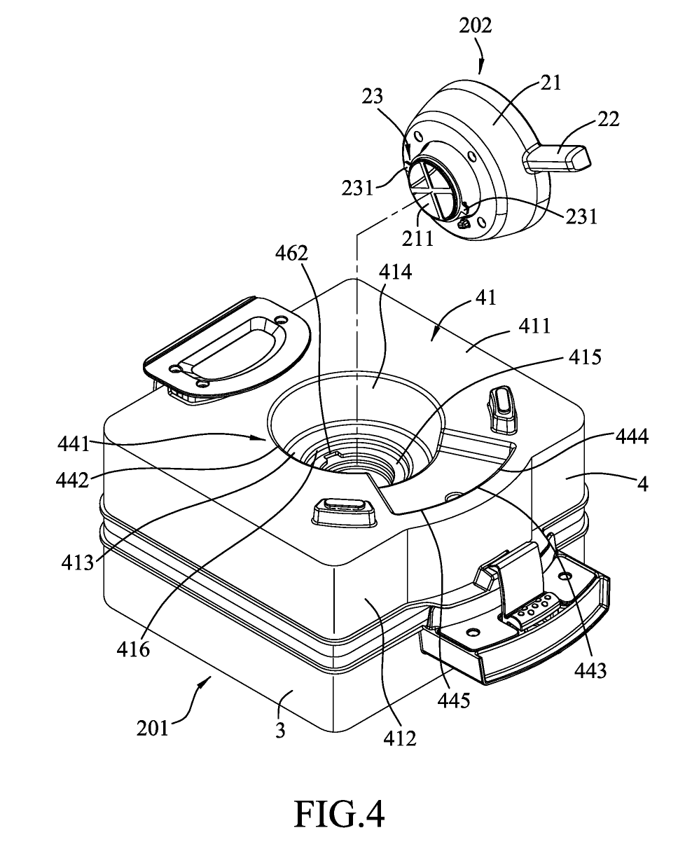

The grilling apparatus includes a case unit 201 and a feeding seat 202. The case unit 201 includes an upper case unit 3 and a lower case unit 4. It should be noted that the embodiment in FIG. 4 is shown upside down to show a bottom side of the case unit 201.

The feeding seat 202 includes a hollow main body 21, a handle 22 fixedly connected to the main body 21, a positioning block unit 23 disposed on a lower end of the main body 21, a blocking wall 24 disposed in the main body 21, and a feeding passage 211. The main body 21 has an annular horizontal cross-section, and defines the feeding passage 211 that is tapered from an upper end of the main body 21 to the lower end of the main body 21. The handle 22 is connected to and extends outwardly from the upper end of the main body 21. The positioning block unit 23 includes two positioning blocks 231 that are respectively disposed on and extend outwardly from two diametrically opposed portions of the main body 21. The blocking wall 24 divides the feeding passage 211 into two sub-passages.

The upper case unit 3 and the lower case unit 4 define a grilling space 5 therebetween and are operable to pivot relative to each other to uncover the grilling space 5. The upper case unit 3 of the case unit 201 has a disposition space 31 for detachably receiving at least a portion of the feeding seat 202 when the grilling apparatus is grilling, and a delivering passage 32 that spatially interconnects the disposition space 31 and the grilling space 5. The engagement between the feeding seat 202 and the upper case unit 3 is well known in the art, and is therefore not elaborated for the sake of brevity.

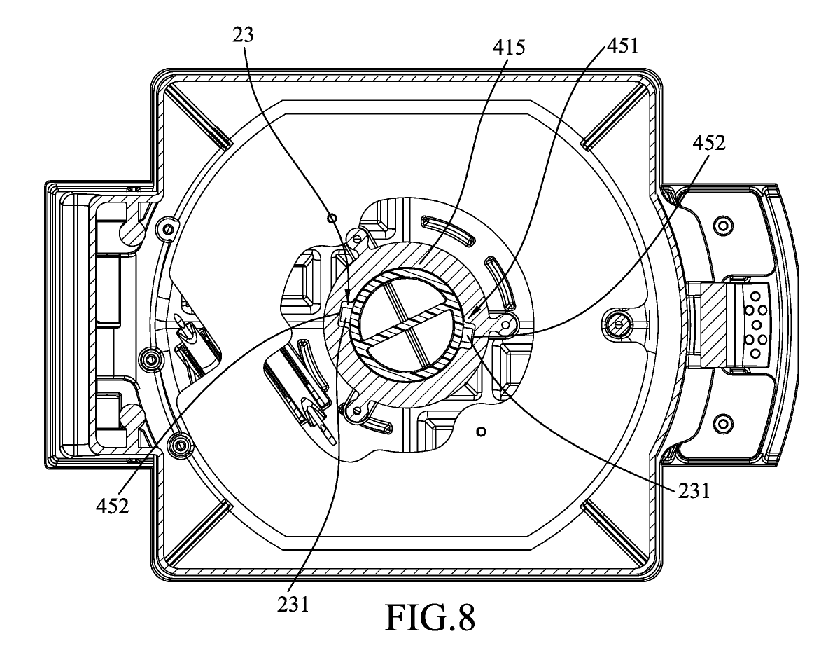

Referring to FIGS. 4 and 6 to 8, the lower case unit 4 includes a case wall 41 and a positioning wall 42 that is spaced apart from and connected to the case wall 41.

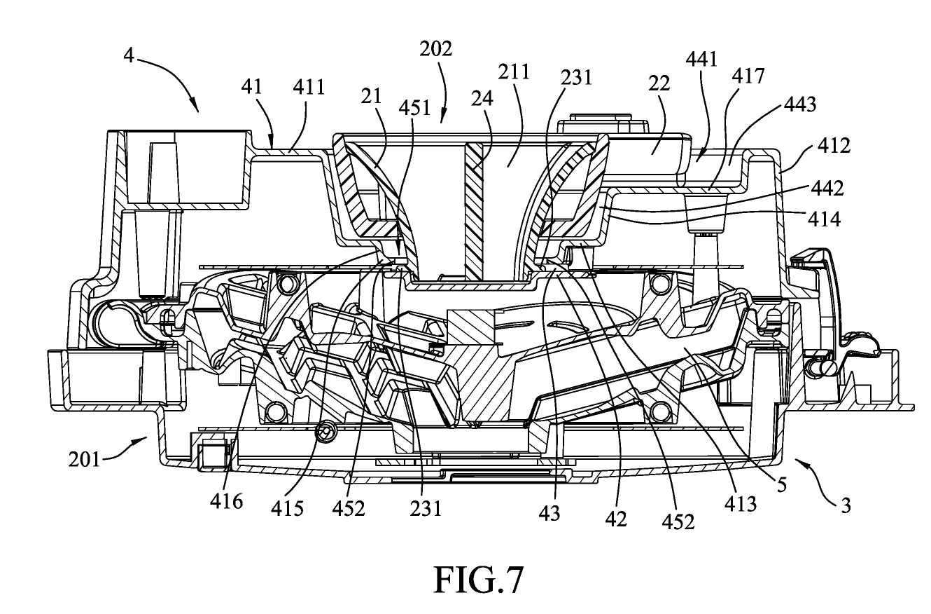

The case wall 41 has a bottom wall portion 411, a surrounding wall portion 412 that extends upwardly toward the upper case unit 3, a horizontal wall portion 413 that is disposed horizontally above the bottom wall portion 411 and that is surrounded by the surrounding wall portion 412, an upright wall portion 414 that is connected between the bottom wall portion 411 and the horizontal wall portion 413, a ring wall portion 415 that is disposed horizontally above the horizontal wall portion 413, a tilting wall portion 416 that is connected between the horizontal wall portion 413 and the ring wall portion 415, and an extending wall portion 417 (see FIG. 7) that extends outwardly from a bottom end of the upright wall portion 414. Each of the bottom wall portion 411, the horizontal wall portion 413 and the ring wall portion 415 is annular. Each of the surrounding wall portion 412, the upright wall portion 414 and the tilting wall portion 416 has a substantial annular horizontal cross-section. The tilting wall portion 416 extends upwardly and inwardly from the horizontal wall portion 413 to connect with the ring wall portion 415. The extending wall portion 417 has a substantial sector shape.

The bottom wall portion 411, the horizontal wall portion 413, the upright wall portion 414, the ring wall portion 415, the tilting wall portion 416 and the extending wall portion 417 of the case wall 41 of the lower case unit 4 cooperatively define a containing recess 441 that is indented upwardly toward the upper case unit 3, and that is for detachably receiving the feeding seat 202 when the grilling apparatus is idling. The containing recess 441 has a main body containing portion 442 and a handle containing portion 443. The main body 21 and the handle 22 of the feeding seat 202 are operable to be respectively received in the main body containing portion 442 and the handle containing portion 443. The main body containing portion 442 is tapered from the bottom wall portion 411 toward the ring wall portion 415, and has a substantial circular horizontal cross-section. The handle containing portion 443 is connected to an upper end of the main body containing portion 442, is defined by the upright wall portion 414 and the extending wall portion 417, and has a sector-shaped horizontal cross-section. The handle containing portion 443 has a first recess segment 444 and a second recess segment 445 that is in spatial communication with the first recess segment 444.

The ring wall portion 415 of the case wall 41 is located under the positioning wall 42, and defines a passing groove unit 451 therebetween that is located near and under the positioning wall 42 and that is in spatial communication with a top portion of the main body containing portion 442 of the containing recess 441. The passing groove unit 451 includes two passing grooves 452 that are formed in an inner wall surface of the case unit 201 defining the containing recess 441 and that are respectively disposed at two diametrically opposed positions of the case wall 41.

The positioning wall 42 is located above the ring wall portion 415 of the case wall 41, and cooperates with the ring wall portion 415 to define a positioning space 43 that is disposed above and in spatial communication with the main body containing portion 442 of the containing recess 441 and the passing grooves 452.

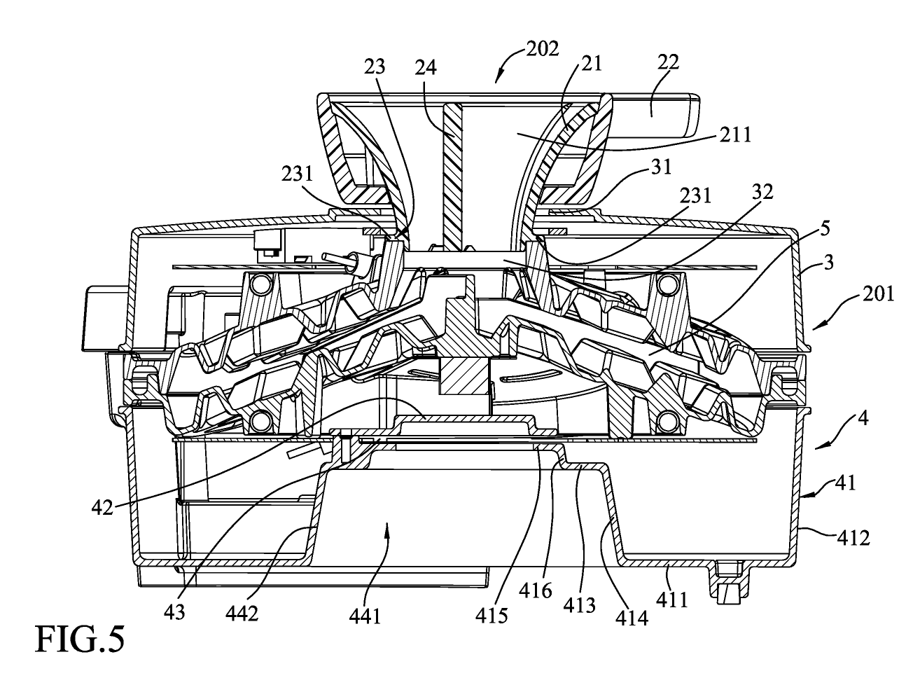

Referring to FIGS. 3 and 5, when it is desired to grill the food material by the grilling apparatus, the feeding seat 202 is detachably mounted to the upper case unit 3 such that the feeding passage 211 of the feeding seat 202 is in spatial communication with the grilling space 5 and is adapted for the food material to enter the grilling space 5 through the feeding passage 211 and to be cooked in the grilling space 5. Since the feeding passage 211 is divided into the two sub-passages by the blocking wall 24, two kinds of food materials can be fed into the grilling spaces, respectively through the sub-passages to obtain dual-flavored waffles. Alternatively, other ingredients, such as nuts, sweets, cereals, etc., can be fed into the grilling space 5 through the sub-passages.

Referring to FIG. 4, when the grilling apparatus is idling, the user can clean the feeding seat 202, followed by putting the feeding seat 202 into the containing recess 441 of the lower case unit 4. During the process of putting the feeding seat 202 into the containing recess 441, the positioning blocks 231 of the feeding seat 202 are respectively aligned with the passing grooves 452 defined by the case wall 41 to allow the feeding seat 202 to enter the containing recess 441. In other words, the positioning block unit 23 is operable to enter the positioning space through the passing groove unit 451 and to be subsequently rotated in the positioning space 43 to be misaligned from the passing groove unit 451, so that the positioning block unit 23 is detachably confined in the positioning space 43.

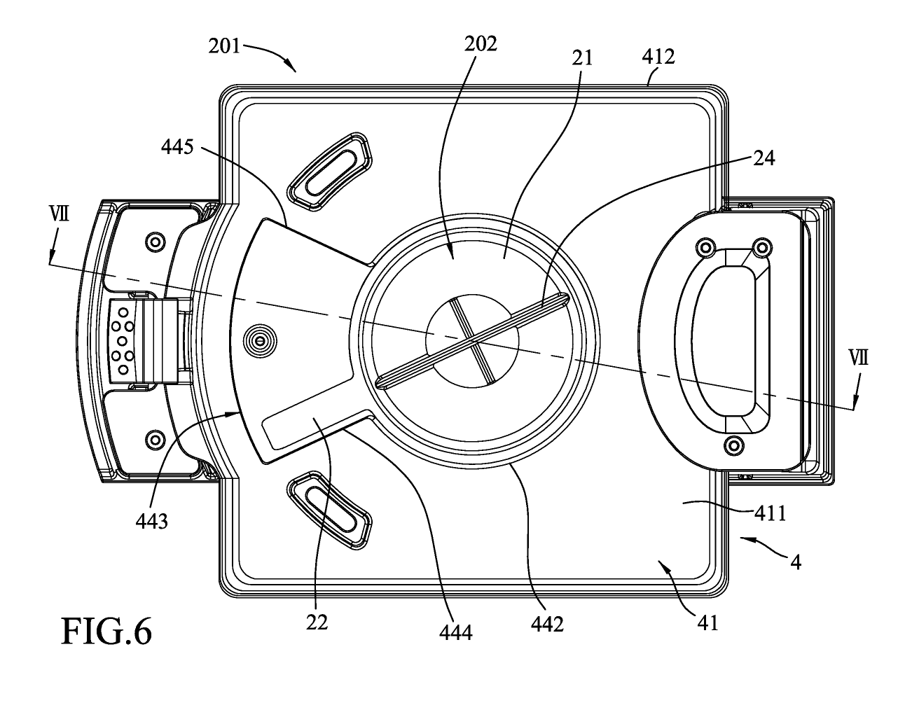

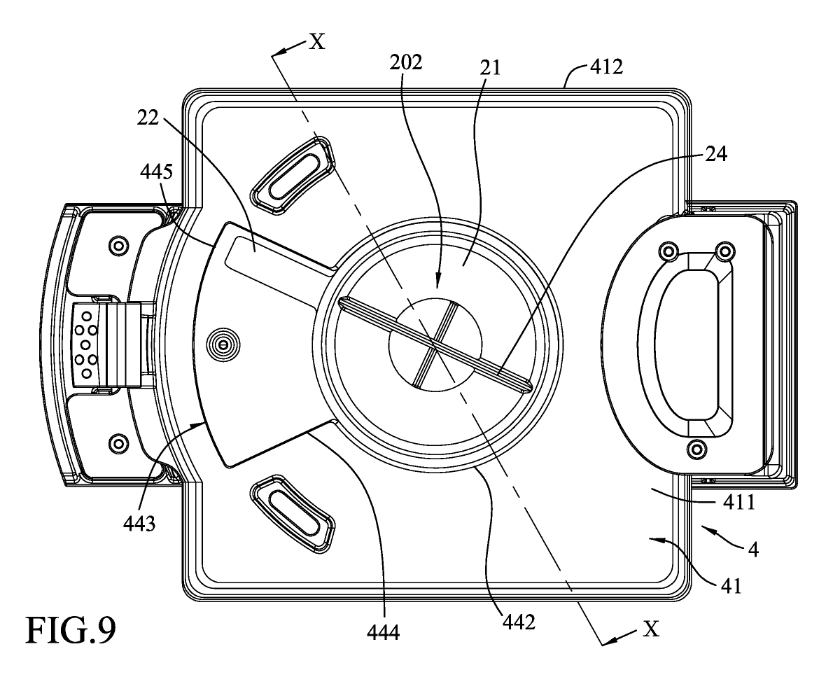

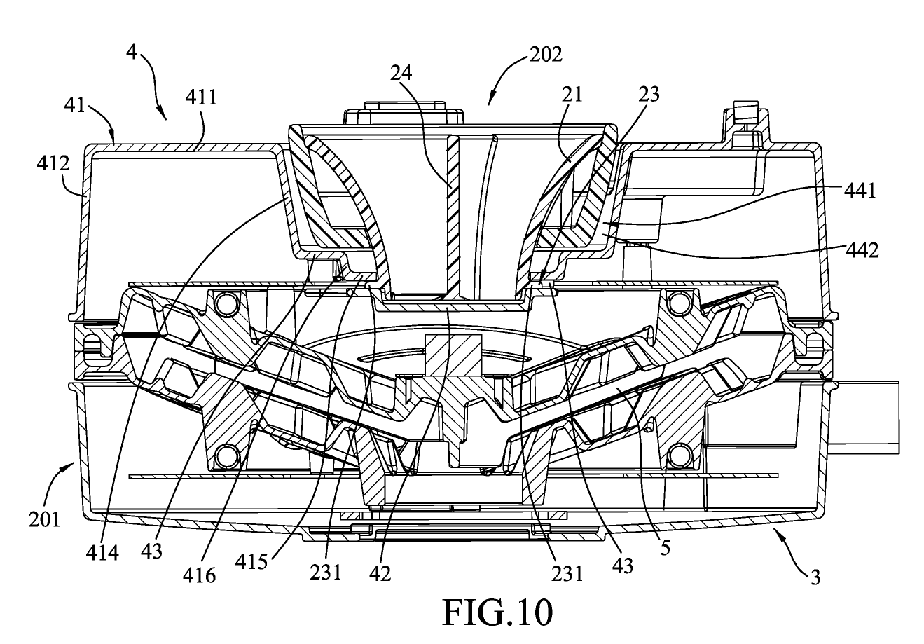

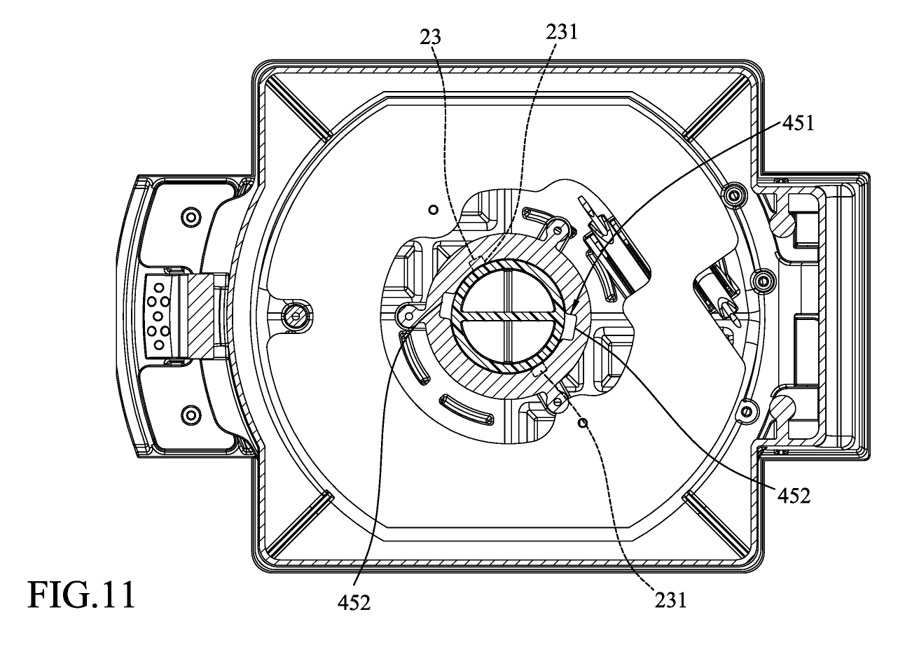

More specifically, referring to FIGS. 6 to 11, the feeding seat 202 is rotatable in the containing recess 441 between a removable position (see FIGS. 6 to 8), where the positioning blocks 231 are respectively aligned with the passing grooves 452 and where the handle 22 is received in the first recess segment 444 of the handle containing portion 443, and a confined position (see FIGS. 9 to 11), where the positioning blocks 231 are respectively misaligned from the passing grooves 452 and where the handle 22 is received in the second recess segment 445 of the handle containing portion 443.

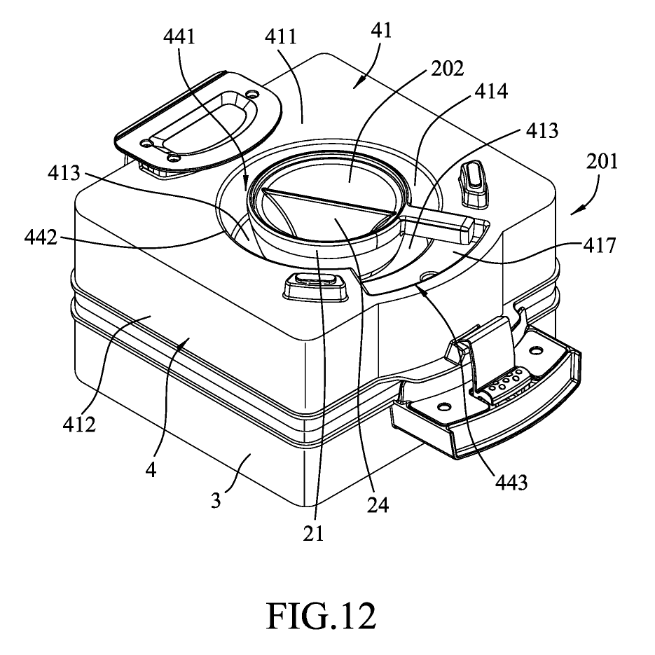

FIG. 12 shows a variation of the embodiment, in which a distance between the upright wall portion 414 of the case wall 41 and the main body 21 of the feeding seat 202 is increased, and the area of the horizontal wall portion 413 is also increased. In other words, the main body 21 of the feeding seat 202 and the main body containing portion 442 of the containing recess 441 are loosely interengaged, thereby facilitating movement of feeding seat 202 into or from the containing recess 441.

To sum up, the feeding seat 202 of this embodiment can be stored in the containing recess 441 when the grilling apparatus is idling, thereby saving storage space for the grilling apparatus.

In the description above, for the purposes of explanation, numerous specific details have been set forth in order to provide a thorough understanding of the embodiment and variation. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiment and variation, it is understood that this disclosure is not limited to the disclosed embodiment and variation but is intended to cover various arrangements included within the spirit and scope of the broadest interpretation so as to encompass all such modifications and equivalent arrangements.

What is claimed is:

1. A grilling apparatus comprising a case unit and a feeding seat, said case unit having a containing recess for detachably receiving said feeding seat.

2. The grilling apparatus as claimed in claim 1, wherein said case unit including an upper case unit and a lower case unit that are pivotable relative to each other, said feeding seat being operable to be detachably mounted to said upper case unit for a food material to be located and cooked between said upper case unit and said lower case unit, said lower case unit defining said containing recess.

3. The grilling apparatus as claimed in claim 2, wherein:
said feeding seat includes a feeding passage, said upper case unit and said lower case unit defining a grilling space therebetween and being operable to uncover said grilling space.

4. The grilling apparatus as claimed in claim 3, wherein said containing recess is indented upwardly toward said upper case unit.

5. The grilling apparatus as claimed in claim 3, wherein said feeding seat further includes a main body that is formed with said feeding passage, and a positioning block unit that is disposed on a lower end of said main body, said lower case unit including a case wall that defines said containing recess, and a positioning wall that is spaced apart from said case wall, said case wall and said positioning wall cooperatively defining a positioning space that is disposed above and in spatial communication with said containing recess, said case wall further defining a passing groove unit that is located near and under said positioning wall and that is in spatial communication with said containing recess and said positioning space, said positioning block unit being operable to enter said positioning space through said passing groove unit and to be subsequently rotated in said positioning space to be misaligned from said passing groove unit, so that said positioning block unit is detachably confined in said positioning space.

6. The grilling apparatus as claimed in claim 5, wherein said feeding seat further includes a handle that is fixedly connected to said main body, said containing recess having a main body containing portion and a handle containing portion, said main body and said handle of said feeding seat being operable to be respectively received in said main body containing portion and said handle containing portion.

7. The grilling apparatus as claimed in claim 6, wherein said positioning block unit includes two positioning blocks that are respectively disposed on two diametrically opposed portions of said main body, said passing groove unit including two passing grooves that are formed in an inner wall surface of said case unit defining said containing recess and that are respectively disposed at two diametrically opposed positions of said case wall, said handle containing portion having a first recess segment and a second recess segment that is in spatial communication with said first recess segment, said feeding seat being rotatable in said containing recess between a removable position, where said positioning blocks are respectively aligned with said passing grooves and said handle is received in said first recess segment, and a confined position, where said positioning blocks are respectively misaligned from said passing grooves and said handle is received in said second recess segment.

8. The grilling apparatus as claimed in claim 6, wherein said main body of said feeding seat has an annular horizontal cross-section, said handle being connected to an upper end of said main body, said handle containing portion being connected to an upper end of said main body containing portion, said main body containing portion having a circular horizontal cross-section, said handle containing portion having a sector-shaped horizontal cross-section.
